(19) United States
(12) Patent Application Publication
(10) Pub. No.: US 2020/0068859 A1
(43) Pub. Date: Mar. 5, 2020

(54) HABITAT FOR HOUSING COLD BLOODED ANIMALS, WARM BLOODED ANIMALS, AND PLANTS

(71) Applicant: Michael C. Smith, Springboro, OH (US)

(72) Inventor: Michael C. Smith, Springboro, OH (US)

(21) Appl. No.: 16/121,724

(22) Filed: Sep. 5, 2018

(51) Int. Cl. A01K 63/00; A01K 63/06

(52) U.S. Cl. CPC A01K 63/003; A01K 63/065

(57) ABSTRACT

The present invention is directed to a habitat for housing either cold blooded animals, warm blooded animals or plants, and in particular it is directed to a habitat for housing cold blooded animals such as lizards including geckos and the like. The present habitat apparatus comprises a transparent terrarium in combination with a stand, the stand including a partition that provides a space to receive and nest the transparent terrarium within so a portion of the transparent terrarium is masked by the partition to create a secure zone within the interior space of the terrarium that is distinct from adjoining interior space.

### FIELD OF THE INVENTION

The present invention is directed to a habitat for housing either cold blooded animals, warm blooded animals or plants, and in particular it is directed to a habitat for housing cold blooded animals such as lizards including geckos and the like. The present habitat apparatus comprises a transparent terrarium in combination with a stand, the stand including a partition that provides a space to receive and nest the transparent terrarium so that a portion of the transparent terrarium is masked by the partition to create a secure zone within the interior space of the terrarium that is distinct from adjoining interior space. The secure zone provides a safe, danger free hideaway area for animals housed therein. The stand further includes a life support system comprising a thermostat connected to send signals that control output temperature of a heat source fixed to the partition and positioned to contact a surface of the transparent terrarium. The present invention also includes means to couple a series of standardized or secondary stands together so that a universal thermostat sends signals to control output temperature in a heat source provided in each of the coupled standardized or secondary stands.

### BACKGROUND OF THE INVENTION

Herpetoculture has become a popular hobby and there is a need to replace traditional glass aquariums and terrariums with improved terrarium and stand arrangements for the hobbyist where the enclosed habitats are designed specifically for herps. In the past, it was common to keep multiple animals in a single transparent enclosure that was open to view from all sides. Such habitats are stressful for herps, and they are extremely stressful for geckos. Geckos are shy animals. They require a secure space or hideaway for proper nurturing. In the past, hideaways were provided as separate structures or devices placed within the terrarium or cage. For example, U.S. Pat. No. 6,701,879 discloses a terrarium (60) that includes a habitat (10) to provide a secure space for a reptile (64). Habitat (10) is placed within the terrarium (60). In such an arrangement animal stress is reduced only after the reptile (64) enters habitat (10). There is no secure zone provided within the habitat (10) because the interior space is open to full view.

It is also desirable to provide a heat source as a life support system in terrariums or cages in order to maintain a habitat temperature suitable for a particular animal housed therein. Various terrariums in the past have provided a heat source in an attempt to maintain a proper temperature for the housed animals. One such example is U.S. Pat. No. 5,272,316 “Heating Apparatus for use by Reptiles or the Like” discloses apparatus that simulates a tree limb (20) and comprises a hollow interior space to house a heating element (112) and an exposed electrical cord (100) that exits from the open top terrarium (44) to a power source. Such open top terrariums fail to be escape proof and are unsuitable for herps. In addition, terrariums that house animals must be routinely cleaned or washed to maintain animal health. Cumbersome apparatus such as tree limb (20) must be disconnected from the power source, disassembled, and removed from the terrarium before proper cleaning can proceed. Such removal requirements add unwanted burden to cleaning procedures.

Another patent that discloses a heat source in a terrarium or vivarium is U.S. Pat. No. 5,713,304. The vivarium (100) includes side glass panels (126) and sliding glass panels (110) that provide front access into the vivarium. A top cover (124) provides a fluorescent lamp (118), monitoring devices (122), a fan (120), and a heat lamp (128). Referring to col. 4, line 52, the inventor states that “As can be seen the removal of the top cover (124) on a vivarium can be time consuming due to the number and type of equipment and the associated wiring which may need to be removed.” The patent clearly teaches that the removal of top cover (124) will add an undo burden to vivarium cleaning and/or washing procedures.

Another noncommercial or hobby type reptile cage, shown in U.S. Pat. No. 5,842,439, discloses a cage (10) that provides an enclosure (12) having a top wall (14). The top wall includes a bucket recess (38) that accommodates a light source (41) to provide heat as well as light. The heat lamp is located “interiorly” of the top wall (14) and it would need to be disconnected and removed prior to cleaning and/or washing. In addition, cage (10) also includes built in light sources (52) and (54) that would need to be removed before cleaning with water or other solvent. Furthermore, U.S. Pat. No. 5,842,439 fails to create a secure zone for housed reptiles.

### SUMMARY OF THE INVENTION

Accordingly, it is a first object of the present invention to provide a stand that includes a partition to nest a transparent terrarium, the partition including side panels shaped to partially mask a nested terrarium to create a secure zone within the interior space of the terrarium that is distinct from adjoining interior space.

It is another object of the present invention to shape the partition side panels of the stand to provide a mask that creates both a secure zone within the interior space of the terrarium and optimum visibility through the terrarium sidewalls into the interior space.

It is a further object of the present invention to provide a stand that includes a life support system comprising a thermostat device having means to regulate the output temperature of a heat source fixed to the stand, the fixed heat source positioned to contact a surface of a terrarium nested within the stand.

It is still a further object of the present invention to provide a terrarium nested within a stand that is removable from its nested position a stand without first disconnecting life support systems, i.e. while the life support system is fully operational.

It is another object of the present invention to provide a primary stand adapted to couple to secondary stands and control the output temperature of a heat source fixed to each coupled secondary stand.

In satisfaction of the foregoing objects and advantages, the present invention is directed to a habitat comprising a transparent terrarium nested within a partition of a stand, the partition masking a portion of the transparent terrarium to create a secure zone within the terrarium that is distinct from adjoining interior space.

As used herein “optimum visibility” means a degree or an amount of visibility attained or attainable under implied or specified conditions.

As also as used herein “partition” means one part or section of a whole, in this instance a part or section of a whole or entire terrarium stand.

As used herein “universal thermostat” means a thermostat capable of delivering both electric power and a signal that controls the output temperature of each heat source fixed to a surface of a coupled secondary terrarium.

### BRIEF DESCRIPTION OF THE DRAWINGS

FIGS. 1a and 1b are isometric views showing the combination habitat apparatus of the present invention where FIG. 1a is a transparent terrarium and FIG. 1b is a stand.

FIG. 2 is an isometric view of the habitat apparatus showing the transparent terrarium of FIG. 1a nested within the stand partition shown in FIG. 1b.

FIG. 3 is another isometric view of the habitat apparatus showing the transparent terrarium of FIG. 1a nested within the stand partition shown in FIG. 1b.

FIG. 4 is an elevation view showing a plurality of secondary stands coupled to the stand in FIG. 1b.

### DESCRIPTION OF THE PRESENT INVENTION

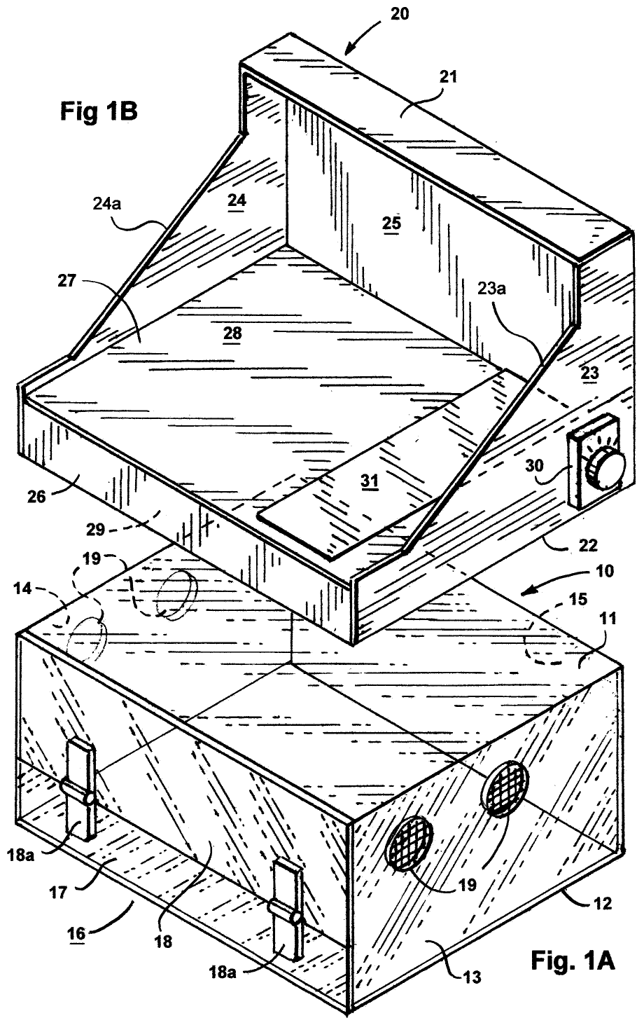

Referring to FIGS. 1a and 1b, FIG. 1a shows a terrarium 10 of the present invention having six transparent walls including a top 11, a base 12, sidewalls 13 and 14, and a backwall 15 opposite a front wall 16. Front wall 16 comprises a fixed panel 17 attached to both sidewalls 13 and 14 and base 12, and a hinged panel 18 attached to fixed panel 17 with hinges 18a so that panel 18 may be opened in an outward direction to provide access to the interior of terrarium 10. Screened apertures 19 are provided to ventilate the interior space of the terrarium.

It should be understood that either or both the base 12 and backwall 15 may comprise a nontransparent material without departing from the scope of the present invention. In addition, a latch, not shown, may be provided to prevent accidental opening of hinged panel 18.

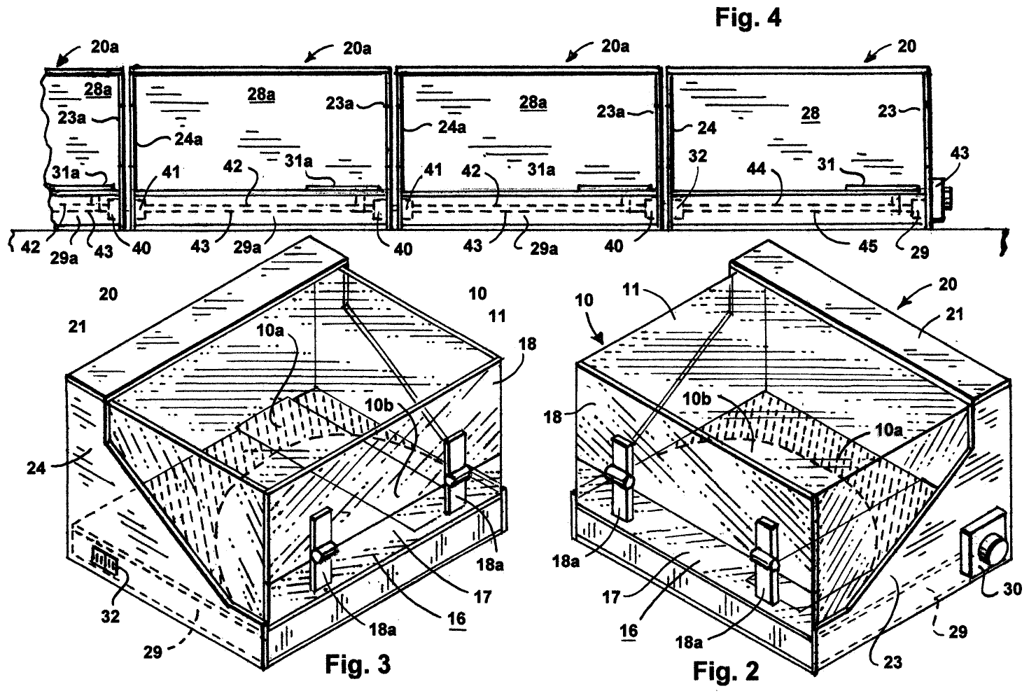

FIG. 1b shows the stand 20 of the present habitat apparatus comprising a top 21, a bottom 22, side panels 23 and 24, a backwall 25, and a front wall 26. A terrarium support panel 27 is positioned above bottom 22 and the terrarium support panel, in combination with the top 21 front wall 26, backwall 25, and both side panels 23 and 24, provides a partition 28 shaped to receive and securely nest terrarium 10 therein as, shown in FIGS. 3 and 4, and support panel 27 bears the load of the nested terrarium. Partition 28 masks the nested terrarium 10 and both side panels 23 and 24 of the partition are shaped to provide downward sloping edges 23a and 24a respectively so that the partition mask provides a secure zone 10a, (shown with diagonal lines in FIGS. 3 and 4), that is distinct from adjoining interior space 10b. In the present embodiment, the partition side panels mask about 39% of the total sidewall area of the nested transparent terrarium. The 39% mask greatly reduces or eliminates stress in animals housed within the terrarium and it also exposes an optimum visibility through the terrarium sidewall portions that are not masked.

It should be understood that, although the preferred embodiment discloses side panels 23 and 24 having downward sloping or diagonal edges to provide a preferred 39% mask. However, different shaped side panels may be used without departing from the scope of the invention, and that the masked area percentage may also be adjusted in response to needs of an animal housed within terrarium 10 without departing from the scope of the present invention. However, depending on the particular animal housed within the transparent terrarium 10, the stand side panels 23 and 24 may be shaped to mask between about 10% to about 80% of the transparent terrarium sidewalls 13 and 14.

The terrarium support panel 27, in combination with bottom 22, front wall 26, backwall 25, and both side panels 23 and 24 provides a closed space or chamber 29 between support panel 27 and bottom 22 to accommodate wiring associated with life support apparatus. In the present embodiment, a thermostat 30 is attached to stand 20 and adjacent chamber 29 so that both power and temperature control connections to a heat source 31 can be made within the chamber. Heat source 31 is fixed to the terrarium support panel 27 at a location to contact the base 12 of terrarium 10 when the terrarium is nested within partition 28. Although the preferred embodiment shows heat source 31 fixed to support panel 27, a heat source may be fixed to any partition surface adjacent the nested terrarium without departing from the scope of the present invention.

FIGS. 3 and 4 show terrarium 10 nested within the partition 28 of a stand 20 with side panels 23 and 24 providing a total mask area of about 39% over the terrarium sidewalls 13 and 14. The 39% sidewall masking area provides a secure zone 10a within the interior of terrarium 10 that is distinct from adjoining interior space 10b. As used herein, the term nested means the terrarium 10 and the partition 28 are made to fit close together when nested, i.e. “near surface-to-surface contact,” to provide a clearance of about 0.0625 inches and 0.03125 inches between adjacent surfaces. The nested near surface-to-surface contact improves the effectiveness of the 39% sidewall mask area that provides secure zone 10a within the terrarium. The nested near surface-to-surface clearance is elective between the backwall 28 of stand 20 and adjacent wall of the nested terrarium 10. In the preferred embodiment thermostat 30 is attached to sidewall 23 and at least one receptacle 32 is fixed to sidewall 24. A power line and a thermostat signal line from the thermostat is connected to the heat source 31 and receptacle 32, the connections made in closed chamber 29. However, an in an alternate embodiment thermostat 30 may just as well be attached to sidewall 24 and receptacle 32 fixed to sidewall 23 with similar connections to the heat source and receptacle being made as described above.

Referring to FIG. 4, primary stand 20 of the habitat apparatus is shown positioned adjacent a series of secondary stands 20a or stands 20a. Each stand 20a includes a heat source 31a fixed to a surface within partition 28a as described above for heat source 31 and partition 28 and as shown in FIG. 1b. At least one receptacle 40 is fixed to sidewall 23a of each stand 20a and at least one receptacle 41 is fixed to the opposite sidewall 24a. A power line 42 provided within closed chamber 29a connects heat source 31a, receptacle 40, and receptacle 41 together in either a series or parallel circuit, and a thermostat signal line 43 also enclosed within chamber 29a connects heat source 31a, receptacle 40, and receptacle 41 together in a similar series or parallel circuit. A universal thermostat 43 is attached to sidewall 23 of primary stand 20. A power line 44 and thermostat signal line 45 extend from the universal thermostat 43 into chamber 29 and both lines are connected to heat source 31 and receptacle 32 as described above. Receptacle 40 provided in the adjacent stand 20a is coupled to receptacle 32 in primary stand 20 to connect the universal thermostat 43 to the power and the temperature control circuits provide in the adjacent stand 20a. This connection enables the universal thermostat to provide power to both heat sources 31 and 31a as well as control the heat source 31 and 31a temperature.

FIG. 4 further shows a series of secondary terrarium stands 20a coupled together through their adjacent receptacles 40 and 41 so that the power circuit and temperature control circuit provided in each successive stand 20a communicates with and is controlled by the universal thermostat 43 provided in primary stand 20.

Thus, specific and alternate embodiments of a habitat for housing cold blooded animals, warm blooded animals, and plants have been disclosed. Of course, those skilled in the art may contemplate various changes, modifications, and alterations from the teachings of the present disclosure without departing from the intended spirit and scope of the inventive concepts herein. Moreover, in interpreting the disclosure, all terms should be interpreted in the broadest possible manner consistent with the context. In particular, the terms “comprise” and “comprising” should be interpreted as referring to elements or components in a non-exclusive manner, indicating that the referenced elements or components may be present, or utilized, or combined with other elements, components that are not expressly referenced.

I claim:

1) A habitat apparatus comprising:
a) a transparent terrarium having a top, a base, sidewalls, and a backwall opposite a front wall, said front wall including a fixed panel attached to said sidewalls and base, and a hinged panel attached to said fixed panel, said hinged panel attached to open in an outward direction;
b) a stand comprising;
i) a partition including a terrarium support panel, said partition configured to nest said transparent terrarium therein, said partition shaped to mask a portion of said transparent terrarium to create a secure zone within an interior space of said transparent terrarium distinct from an adjoining interior space, and
ii) a life support system comprising a thermostat fixed to said stand and connected to a heat source attached to a surface of said partition at a location to contact a surface of a transparent terrarium nested within the partition, said thermostat connected to control output temperature of said heat source.

2) The habitat apparatus recited in claim 1, wherein said partition includes side panels shaped to mask a portion of said transparent terrarium sidewalls to create said secure zone within the interior space and to also expose a portion of said sidewalls to provide an optimum visibility through said sidewalls into said interior space.

3) The habitat apparatus recited in claim 2, wherein said shaped side panels mask between about 10% to about 80% of the transparent terrarium sidewalls.

4) The habitat apparatus recited in claim 2, wherein said shaped side panels mask 39% of the transparent terrarium sidewalls.

5) The habitat apparatus recited in claim 1, wherein said stand partition is shaped to receive said nested transparent terrarium in a near surface-to-surface contact within said stand partition.

6) The habitat apparatus recited in claim 5, wherein said near surface-to-surface contact provides a clearance of about 0.03125″ to about 0.0625″ between adjacent surfaces of said stand partition and said nested transparent terrarium sidewalls.

7) The habitat apparatus recited in claim 1, whereby said nested transparent terrarium is removable from said partition while said life support system is fully operational.

8) A habitat apparatus comprising:
a) a primary stand for supporting a terrarium including a partition shaped to receive and nest a terrarium, said partition including a first side panel opposite a second side panel each side panel positioned adjacent a sidewall of said nested terrarium, each said side panel shaped to mask at least 10% of said adjacent sidewall to create a secure zone within an interior space of said nested terrarium distinct from an adjoining interior space within said nested terrarium,
i) a closed chamber attached to and positioned below said partition so that the closed chamber supports said stand,
ii) a life support system comprising a universal thermostat fixed to said stand, said universal thermostat including, a first electrical circuit housed within said closed chamber and connected to a heat source fixed to said partition at a location to contact a surface of said nested terrarium and connected to a receptacle fixed to said stand, and a second electrical circuit that provides temperature control signals said second electrical circuit connected to said heat source and said receptacle, and
b) at least one secondary stand comprising a partition shaped to receive and nest a terrarium, said partition including a first side panel opposite a second side panel each side panel positioned adjacent a sidewall of said nested terrarium and shaped to mask at least 10% of said adjacent sidewall to create a secure zone within an interior space of said nested terrarium distinct from an adjoining interior space within said terrarium,
i) a closed chamber attached to and positioned below said partition so that the closed chamber supports said at least one secondary stand,
ii) a first electrical circuit housed within said closed chamber, said first electrical circuit connected to a heat source fixed to said partition at a location to contact a surface of said nested terrarium, said first electrical circuit connected to a first receptacle fixed to said at least one secondary stand and connected to a second receptacle fixed to said at least one secondary stand,
iii) a second electrical circuit housed within said closed chamber to provide temperature control signals, said second electrical circuit connected to said heat source fixed to said partition, said second electrical circuit connected to said first receptacle fixed to said at least one secondary stand and connected to said second receptacle fixed to said at least one secondary stand.

9) The habitat apparatus recited in claim 8, whereby said universal thermostat controls output temperature of said heat source fixed to said partition of said primary stand and said universal thermostat controls output temperature of said heat source fixed to said partition of said at least one secondary stand.

10) The habitat apparatus recited in claim 8, wherein said shaped side panels mask between about 10% to about 80% off said adjacent sidewall.

11) The habitat apparatus recited in claim 8, wherein said shaped side panels mask 39% of said adjacent sidewall.

12) The habitat apparatus recited in claim 8, wherein said stand partition is shaped to receive said nested transparent terrarium in a near surface-to-surface contact within said stand partition.

13) The habitat apparatus recited in claim 12, wherein said near surface-to-surface contact provides a clearance of about 0.03125″ to about 0.0625″ between adjacent surfaces of said stand partition and said nested transparent terrarium.

14) The habitat apparatus recited in claim 9, whereby said nested terrarium is removable from said master stand partition and said terrarium is removable from said at least one secondary stand partition while said life support system is fully operational.
